(19) United States
(12) Patent Application Publication
(10) Pub. No.: US 2010/0265181 A1
(43) Pub. Date: Oct. 21, 2010

(54) System, method and computer readable media for enabling a user to quickly identify and select a key on a touch screen keypad by easing key selection

(75) Inventor: Michael Wayne Shore, Dallas, TX (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: ShoreCap LLC, Dallas, TX (US)

(21) Appl. No.: 12/386,596

(22) Filed: Apr. 20, 2009

(51) Int. Cl. G06F 3/02; G06F 3/041

(52) U.S. Cl. 345/168; 345/173

(57) ABSTRACT

In the embodiments of the present invention, a system, method and computer useable medium are introduced that increase the efficiency in which a user can interface, through keys prediction, with a system that includes a touch screen display, a computer usable medium; having a computer readable instructions for controlling a computer, a computer processor, and a predictive algorithm. This method provides the user with the ability to quickly identify and select, through the enhanced keys prediction, and display the keys of the cell phone or electronic media. The keys include but are not limited to, icons, numbers, symbols and their combinations. In addition, the computer processor and the predictive algorithm, using the keys that are inputted through the touch screen or keypad, anticipate the icons, numbers and symbols necessary to complete the interface request resulting in increase user efficiency.

### BACKGROUND OF THE INVENTION

The present disclosure is directed to touch screens and more particularly to improvements in touch screens so as to provide users with a simplified interface through prediction of icon selection, touch screen interface modification and icon size modification and the like.

Portable devices have been shrinking in dimension almost since their inception. The reduction in size has benefits from a manufacturing and logistics perspective, in that smaller items are typically less costly to manufacture once the technology has been mastered and smaller devices are typically less expensive to package and ship. Additionally, initially small electronics are typically sold at a premium. As just one example, the first thin digital watch cost approximately the same as a compact car when first introduced.

The premium on size does have a downside, and that is the human interface portion. Humans still need to interact with the devices they purchase and the shrinking of the size of devices has made this interface progressively more difficult. Adding for example alphanumeric keyboard features to facilitate texting on cell phones, makes a difficult situation worse.

At present the size of buttons on cell phones are principally constrained by the width of human fingers. If a soft keyboard is used as part of a touch screen a need was felt for an intelligent interface which would allow greater ease to use the on screen keyboard. In particular embodiments of this invention were sought that allowed resizing of a soft keyboard on the fly based upon calculated probabilities that specific keys would be selected next with the concomitant reduction or removal of keys that would probably not be selected. Removal may mean either diminishing in either size or illumination, so that the key is less visible, or complete removal from the keyboard.

### SUMMARY OF THE INVENTION

One of the embodiments provides a system or method that increases the efficiency in which a user can interface with a cell phone or other electronic media, through the use of a touch screen and a displayed touch screen keypad, a computer usable medium; comprising computer readable instructions for controlling a computer, a computer processor and predictive algorithm that reduces user workload. As the capabilities of electronic media increases, the need for more efficient methods of interfacing with those electronic media also increases.

In another embodiment, after the initial inputs from the user, the computer usable medium enables a user to quickly identify and select the next keys on a touch screen keypad executing the steps of, receiving from the touch screen or touch screen keypad the user selected area for selecting at least one keys from the group comprised of icons, numbers, letters and symbols. Once the key or keys are received the next step is to identify one or more predicted keys that a user may next select, and present those on the touch screen keypad for the next selection. The keys provide through the predictive process are ideally substantially enlarged or with increased illumination (or both) and include alphanumeric text. Further the predictions can be improved by taking into account past selections made by the user, lexicon statistics, subject matter, and/or geographic location or combinations thereof.

According to an additional embodiment, at the same time the predicted keys are provided, the computer useable medium infers a set of unlikely keys. These unlikely keys are excluded from the identified one or more predicted keys. When presented the set of unlikely keys on the touch screen or touch screen keypad are substantially reduced in size and/or illumination from the predicted and initial keys (or both).

In another embodiment, the method increases the user friendliness of touch screen interfaces with a computer processor, by providing a means to enhance the visibility and interactions of touch screen or touch screen keypad activities on small touch screens. As the information displayed on the screens of electronic media increases, difficulty in identifying and selecting the different options also increases to the point that user interface efficiencies decrease. This method enhances the displayed information by increasing the size and illumination intensity of the predicted keys and decreasing the size and illumination intensity of non predicted keys, with the purpose of enhancing identification and selection efficiencies.

In still yet another embodiment, the method allows the rapid identification and selection of at least one keys, represented as, but not limited to, icons, numbers, letters, symbols and combinations thereof. The keys are accessed through a fully functional and interactive touch screen or touch screen keypad that is displayed in an adjustable area designated on the touch screen of an electronic media.

According to a further embodiment, the system includes a touch screen on the electronic media that can be organized in a manner that provides a more user friendly functional keypad interface. The keypad area, designated within the touch screen, can for example be adjusted by contacting the edge or corner of the designated area on the touch screen and dragging the edge or corner to either increase or decrease the size of the keypad area. As the area of the designated keypad increases or decreases, the size of the keypad increases or decreases proportionally.

According to still another embodiment, the keypad located in the designated area within the touch screen can be minimized and displayed on an edge of the touch screen as appropriate keys (which are defined as the keyboard icon), where the minimized touch screen area can later be reactivated and returned to full or almost full size and operational capability. During this period of minimization, the entire area designed for the keypad can be utilized to display the predicted keys with greater size and/or illumination or both. To enhance visibility, the enlarged key size can for example, can be ideally at least twice the initial keys size.

In accordance with an additional embodiment, a predictive algorithm is used to anticipate and display one or more keys on the designated keypad. The predictive algorithm uses an adjustable set of criteria which includes previous selections made by the user, lexicon statistics, subject matter, geographic location, previous purchases, previously dialed phone numbers, and previously inputted personal identification numbers to predict the next keys in a series of keys required to complete the data input requirement. The predicted keys or keys can be selected or an alternative selection can be made from the remaining keys located on the keypad.

According to yet another embodiment, the keys are entered through the touch screen or keypad into the electronic media, predicted keys that anticipate the users input requirements appear on the touch screen or keypad significantly enlarged and illuminated, over the non predicted keys, to enhance identification and selection and increasing the efficiency of the interfacing activities. The size of the keys can be adjusted for example to ideally be at least two times their initial size though the use of formatting options located on a menu bar provided on the edge of the touch screen area designated for the keypad.

In a further representation of the present invention, the predicted keys will initially be enlarged and intensified to be ideally twice the size of the remaining displayed keys. In addition, when at least one of the keys is selected, whether predicted or not, the selected keys or keys will become intensified and enlarged over the remaining not selected keys or keys, by at ideally twice the size.

In an additional embodiment, the user can either select at least one of the predicted keys on the touch screen display or return to the keypad and continue to interface with the electronic media. For the purpose of this description, pop-up menus are generated either automatically by the predictive algorithm or through the initiative of the user on the touch screen keypad. The pop-up menus can also be represented on the touch screen as icon keys. When selected the icon keys result in the activation of the associated pop-up menu.

In yet a further embodiment, on the electronic media touch screen, through the computer processor, multiple keypad formats can be selected from a menu bar. The formats include, but are not limited to QWERTY, Dvorak Simplified, alphabetical, numeric, and alphanumeric. Each keypad format includes international language, scientific formula, or iconic character key options, which are again selected from a pop-up menu. The actual key size, as a percentage of the original font size or font size can also be selected from a pop-up menu. In fact, a formatting capability allows different fonts, font style or font sizes, font intensities, colors or the like to be selected from a menu or other means of selecting. This can for example be accomplished in a pop-up menu selector.

The present invention also includes, a predictive algorithm, in conjunction with the computer processor, progressively uses subsequent inputs from the keypad to refine the predictive process. As the predictive process progresses, a set of predicted keys is generated and a set of non-predicted keys is inferred. The elements of the inferred set of non-predicted keys are progressively dimmed and minimized until they are effectively removed from the touch screen as the likelihood of their prediction decreases. At the same time, the size and illumination of the non-predicted keys and unlikely keys is diminished, the size and illumination of the predicted keys increases proportionally.

In yet another embodiment, as the size and illumination of the predicted keys increases, the inferred set of non-predicted keys will be progressive extruded from the center of the designated keypad area. There after the non-predicted keys are grouped into a single area adjacent to the central keypad area and are diminished in size and illumination until they are eventually removed from the keypad area. The predicted keys that have not been extruded from the center of the keypad area will maintain their order on the keypad and touch screen and be displayed in a larger and more intense format. An example of this would include the following keys: “Q”,“W”,“E”,“R”,“T”,“Y”. If the “R” and “T” were extruded from the keypad, the remaining keys displayed on the keypad would appear as “Q”, “W”, “E”, “Y”, each maintaining in their previous order on the keypad. This order would also be maintained on the touch screen if the keys pad was minimized.

In accordance with another embodiment, each key that is displayed either on the touch screen or keypad has an actuation area ideally equal to the size of the respective key. This actuation area allows the selection of the keys and provides an indication of the selection to the computer processor. As the size of the keys increases or decreases, the computer processor adjusts the corresponding size of the actuation area so that area in which a key or keys can be selected on the screen increases or decreases proportionally. If the size of the key is substantially increased, its actuation area is also ideally substantially increased. If the size of the keys is substantially reduced, its actuation area is also ideally substantially reduced.

In a further embodiment, a system comprising the touch screen of the electronic media is communicatably coupled to a computer processor, wherein the processor, using a predictive program to identify one or more keys that a user may next select, presents the predicted keys on the touch screen keypad. When the touch screen keypad is minimized the predicted keys are enlarged to substantially fill the area of the touch screen previously occupied by a touch screen keypad initially provided to the user. The inferred unlikely keys are displayed on the touch screen substantially reduced. When touch screen keypad is not minimized the predicted keys are displayed on the keypad at least twice the size of the initial keys displayed on the keypad.

In an additional embodiment, the keypad, through the computer processor, can be selected to be alternatively minimized or maximized by the user. When the keypad is minimized, the displayed predicted keys are displayed on the touch screen. When the keypad is maximized, the predicted keys are displayed on the keypad. If the keypad changes state from minimized or maximized the displayed predictive keys will also change displayed state from being displayed on the keypad to being displayed on the touch screen and vice versa.

### BRIEF DESCRIPTION OF THE DRAWINGS

FIG. 1 is a view of the touch screen on a cell phone or other electronic media. The touch screen includes a designated area for a keypad containing interactive keys, a display area and a menu bar at the top edge of the display area.

FIG. 2 is a block diagram of the preferred embodiment of the method in which predicted keys are enlarged.

FIG. 3 a front view of the touch screen in which predicted keys are enlarged.

FIG. 4 is a front view of the touch screen in which the predicted keys are enlarged and the keys not predicted are removed from the touch screen keypad.

FIG. 5 is a front view of the touch screen in which non-predicted keys are diminished in size, or diminished in both size and illumination and in which predicted keys may become either larger or larger and more brightly illuminated than non-predicted keys.

FIG. 6 is a block diagram of the preferred embodiment of the method in which the prediction algorithm is may be modified by a set of criteria.

FIG. 7 is a block diagram of a second embodiment of the method.

FIG. 8 is a front view of the touch screen in which unlikely keys have been removed from view.

FIG. 9 is a block diagram of a third embodiment of the method.

FIG. 10 is a front view of the touch screen of a third embodiment of the method in which predicted keys are enlarged and unlikely keys are reduced in size, grouped and segregated on the touch screen keypad.

FIG. 11 is a block diagram of a fourth embodiment of the method.

FIG. 12 is a front view of the touch screen of a fourth embodiment of the method in which predicted keys have an enlarged actuation area and unlikely keys have a reduced actuation area.

FIG. 13 is a block diagram of a preferred embodiment of the system.

FIG. 14 is a front view of the touch screen of a preferred embodiment of the system in which the predicted keys substantially fill the actuation area of the touch screen.

FIG. 15 is a block diagram of a second embodiment of the system.

FIG. 16 is a front view of the touch screen of a second embodiment of the system in which unlikely keys are substantially reduced in size.

FIG. 17 is a block diagram of a third embodiment of the system.

FIG. 18 is a front view of the touch screen of a third embodiment of the system in which only the predicted keys remain on the touch screen.

FIG. 19 is a block diagram of a fourth embodiment of the system.

FIG. 20 is a front view of the touch screen of a fourth embodiment of the system in which predicted keys are enlarged and unlikely keys are substantially reduced in size.

FIG. 21 is a block diagram of a fifth embodiment of the system.

FIG. 22 is a front view of the touch screen of a fifth embodiment of the system in which predicted keys have a substantially enlarged actuation area and unlikely keys have a reduced actuation area.

FIG. 23 is a block diagram of a preferred embodiment of the computer readable media.

FIG. 24 is a front view of the touch screen of a preferred embodiment of the computer readable media in which the predicted keys are enlarged and the keys not predicted are removed from the touch screen keypad.

FIG. 25 is a block diagram of a second embodiment of the computer readable media.

FIG. 26 is a front view of the touch screen of a second embodiment of the computer readable media in which unlikely keys are substantially reduced in size.

FIG. 27 is a block diagram of a third embodiment of the computer readable media.

FIG. 28 is a front view of the touch screen of a third embodiment of the computer readable media in which predicted keys are enlarged and unlikely keys are substantially reduced in size.

FIG. 29 is a block diagram of a fourth embodiment of the computer readable media.

FIG. 30 is a front view of the touch screen of a fourth embodiment of the computer readable media in which predicted keys have a substantially enlarged actuation area and unlikely keys have a reduced actuation area.

FIG. 31 is a block diagram of a fifth embodiment of the computer readable media.

FIG. 32 is a front view of the touch screen of a fifth embodiment of the computer readable media in which the predicted keys are substantially enlarged to fill the entire touch screen keypad and the keys not predicted are removed from the touch screen keypad.

### DETAILED DESCRIPTION OF THE INVENTION

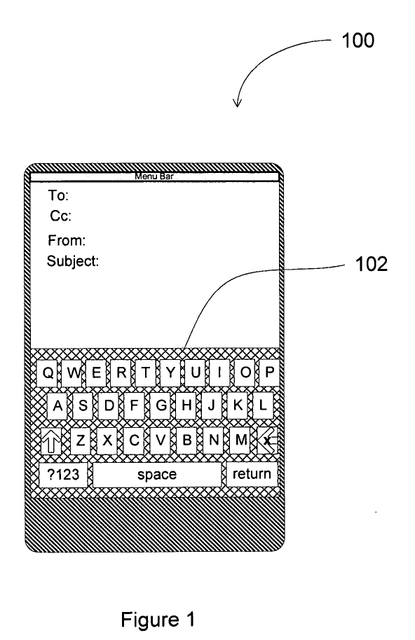

FIG. 1 demonstrates a standard touch screen layout for a portable device such as a cellular telephone or the like. The portable device 100 has a keypad area 102 for the input of alphanumeric data.

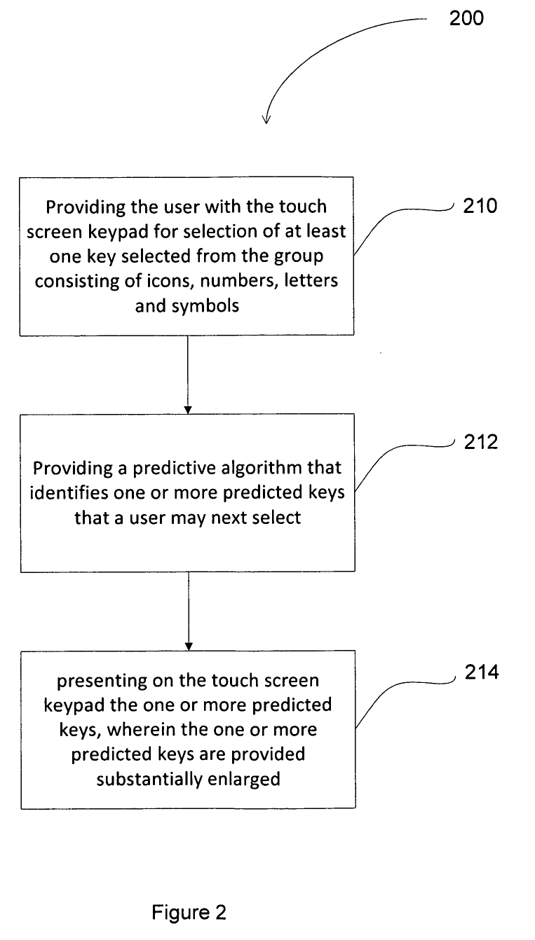

Referring to FIG. 2, a preferred embodiment of a method for enabling a user to quickly identify and select keys on a touch screen keypad 200 includes providing 210 the user with the touch screen keypad for selection of at least one key selected from the group consisting of icons, numbers, letters and symbols. The method provides 212 a predictive algorithm that identifies one or more predicted keys that a user may next select, and presents 214 on the touch screen keypad the one or more predicted keys that are substantially enlarged.

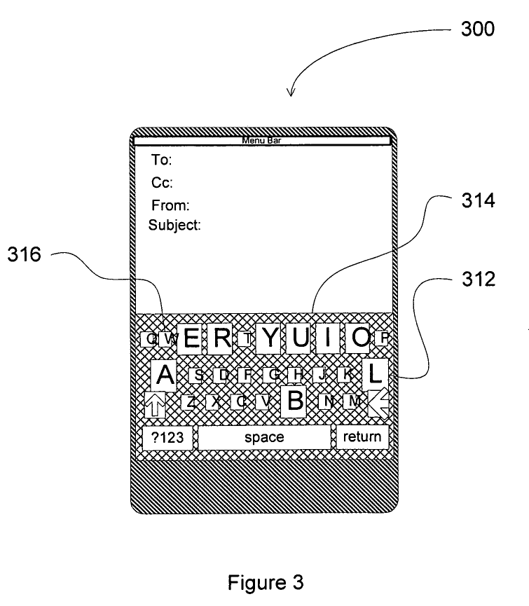

Referring to FIG. 3, the substantially enlarged predicted keys 312 may substantially fill the area of the touch screen 314 previously occupied by the touch screen keypad initially provided to the user, and/or altering the color of the keys not predicted compared to the predicted keys.

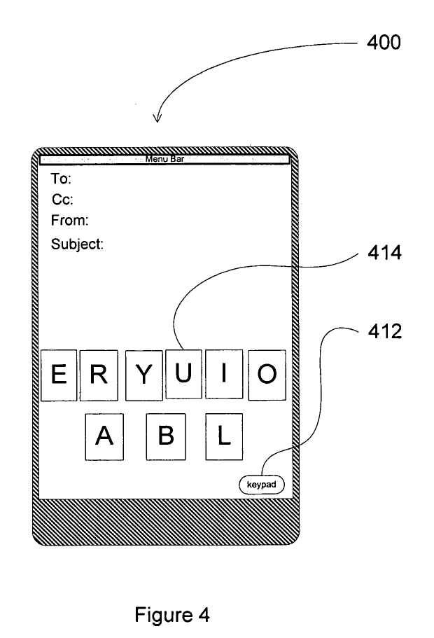

Referring to FIG. 4, keys 412 may be provided for selection which allow the option of retention of the presented touch screen keypad and return to the touch screen keypad initially provided to the user. The size of the predicted keys 414 may be at least twice the size of the original keys on the touch screen keypad initially provided to the user. Keys that are not predicted may be removed as user's choices from the touch screen keypad.

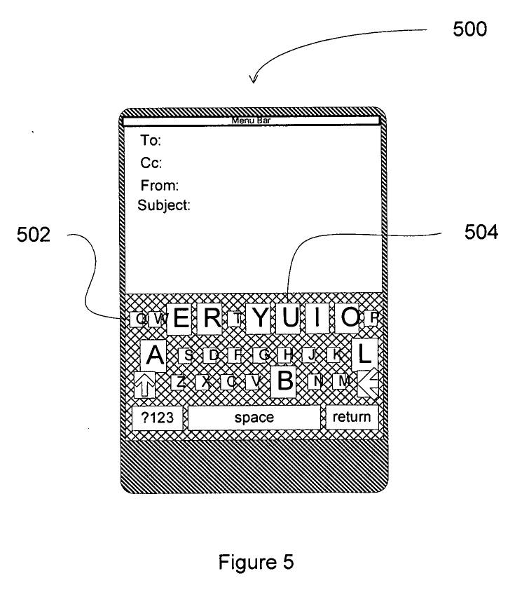

Referring to FIG. 5, the keys 502 may be diminished in size by approximately fifty percent or more, or be both diminished in size by approximately fifty percent or more and reduced in illumination compared to the predicted keys. Additionally, the color of the unlikely keys may be altered compared to the predicted keys. Predicted keys 504 may be increased in illuminated and/or enlarged than the keys not predicted or both. The touch screen keypad may be for example a cellular telephone touch screen keypad, although the system and methodology described herein would likewise work on other devices, such as personal media players or other types of touch activated devices

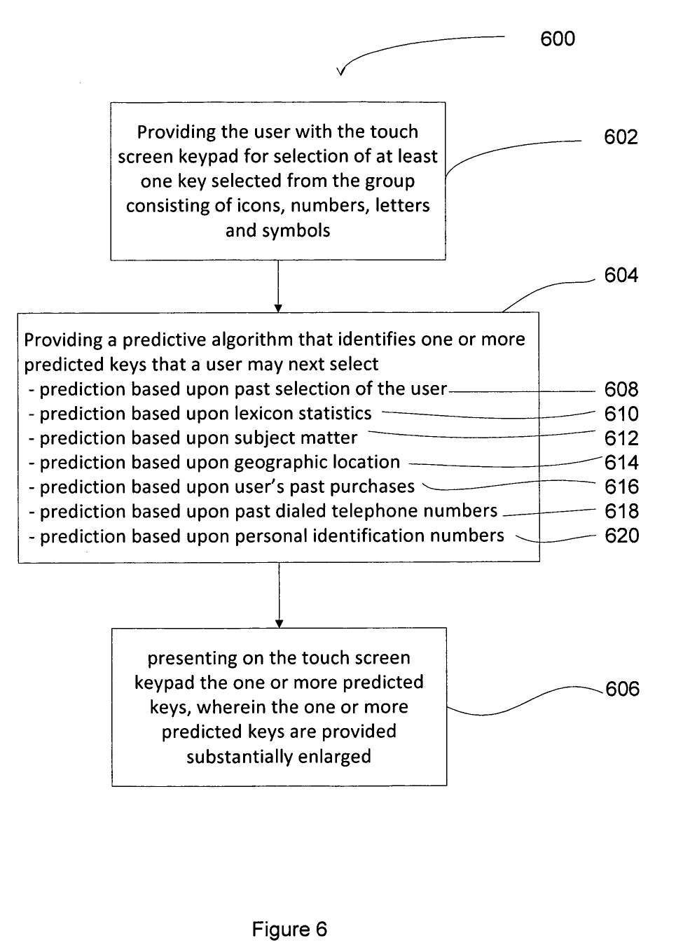

Referring to FIG. 6, the prediction may be based or enhanced using for example past selections of the user 608, lexicon statistics 610, subject matter 612, geographic location 614, user's past purchases 616, past dialed telephone numbers 618, or personal identification numbers 620 or combinations thereof. For example, if the user has in the past dialed a specific number while the phone is located in a away city, the probability of predication of that number would be enhanced.

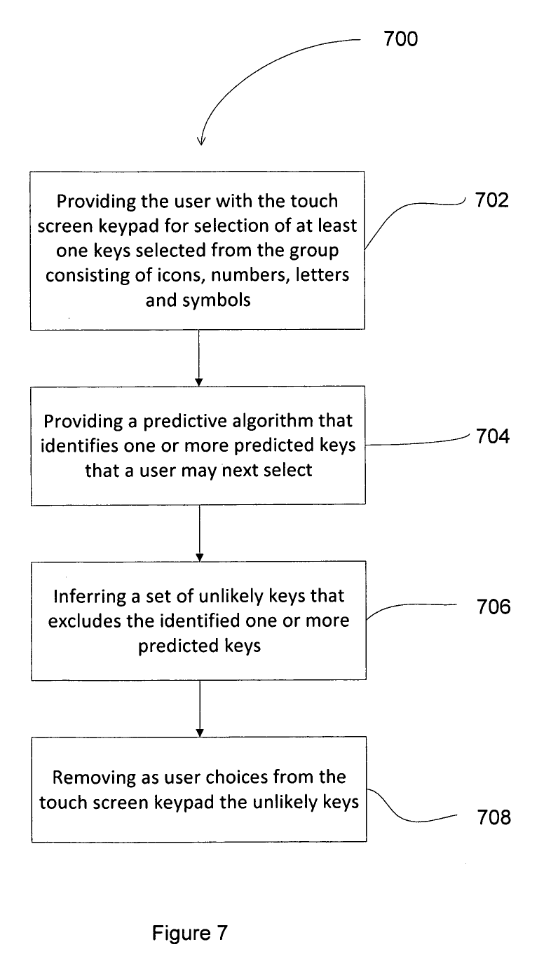

Referring to FIG. 7, a second embodiment 700 is shown of a method for enabling a user to quickly identify and select keys on a touch screen keypad includes providing 702 the user with the touch screen keypad for selection of at least one key selected from the group consisting of icons, numbers, letters and symbols and providing 704 a predictive algorithm that identifies one or more predicted keys that a user may next select. The method also includes inferring 706 a set of unlikely keys that excludes the identified one or more predicted keys, and removing or diminishing 708 unlikely keys as user choices from the touch screen keypad.

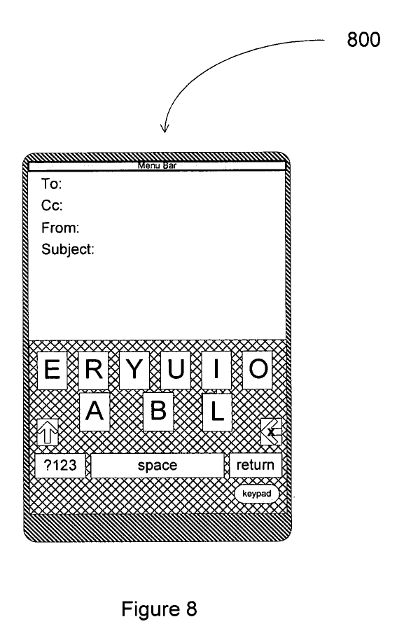

Referring to FIG. 8, the second embodiment 800 of a front view of the touchpad for the method is shown. The unlikely keys have been removed and the predicted keys remain on the touchpad.

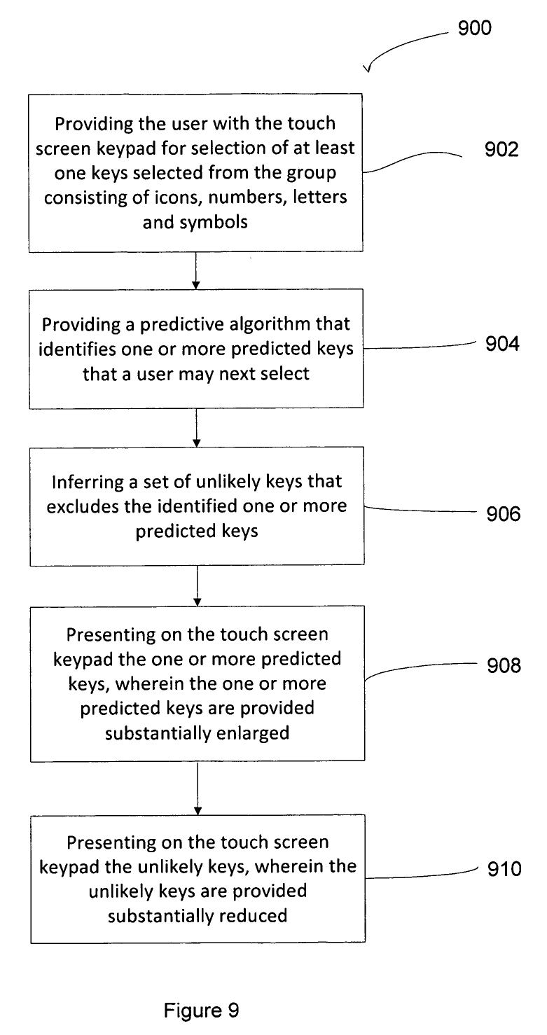

Referring to FIG. 9, a third embodiment 900 of a method for enabling a user to quickly identify and select an keys on a touch screen keypad includes providing 902 the user with the touch screen keypad for selection of at least one keys selected from the group consisting of icons, numbers, letters and symbols and providing 904 a predictive algorithm that identifies one or more predicted keys that a user may next select. The method also includes inferring 906 a set of unlikely keys that excludes the identified one or more predicted keys and presenting 908 on the touch screen keypad the one or more predicted keys and presenting 910 the set of unlikely keys.

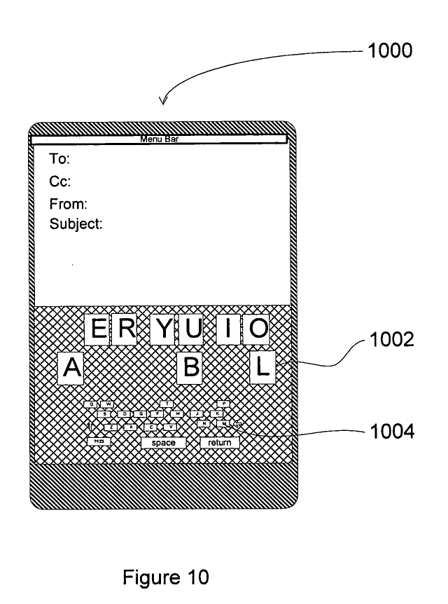

Referring to FIG. 10, the one or more predicted keys 1002 are provided substantially enlarged, and the set of unlikely keys 1004 are provided substantially reduced in size. The method may additionally include reducing illumination of the unlikely keys and or increasing illumination of the predicted keys where the unlikely keys are grouped and segregated into a separate area of the display from the predicted keys. Additionally, the color of the unlikely keys may be altered compared to the predicted keys.

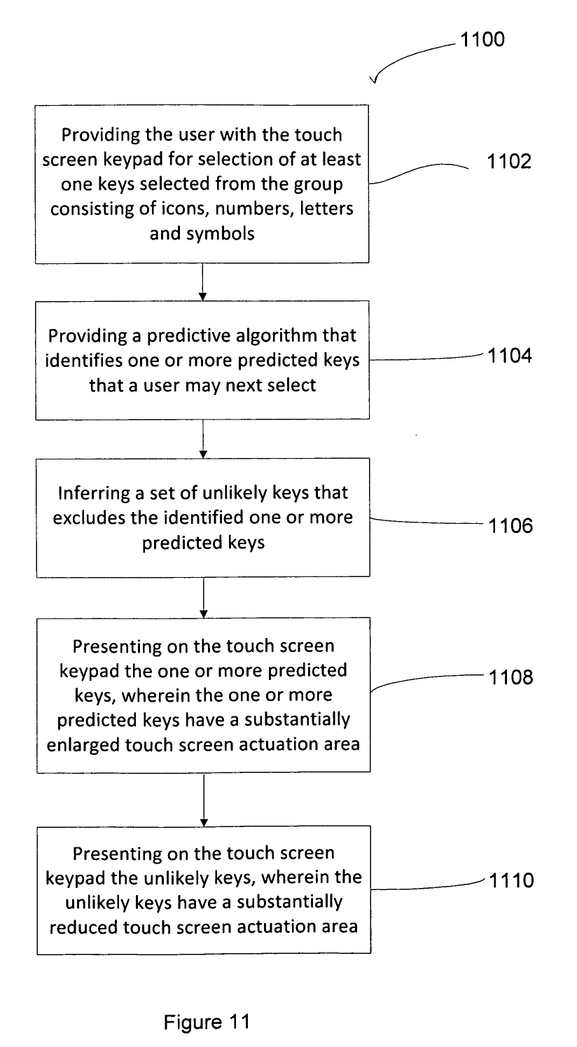

Referring to FIG. 11, the fourth embodiment 1100 of a method for enabling a user to quickly identify and select a key on a touch screen keypad includes providing 1102 the user with the touch screen keypad for selection of at least one keys selected from the group consisting of icons, numbers, letters and symbols and providing 1104 a predictive algorithm that identifies one or more predicted keys that a user may next select. The method also includes inferring 1106 a set of unlikely keys that excludes the identified one or more predicted keys and presenting 1108 on the touch screen keypad the one or more predicted keys where the one or more predicted keys have a substantially enlarged touch screen actuation area and presenting 1110 on the touch screen keypad the unlikely keys, where the unlikely keys have a substantially reduced touch screen actuation area.

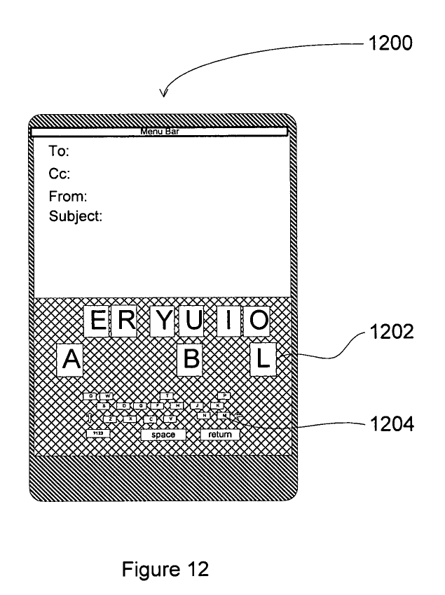

Referring to FIG. 12, the touch screen keypad layout 1200 shows the one or more predicted keys 1202 where the one or more predicted keys have a substantially enlarged touch screen actuation area and the unlikely keys 1204, that have a substantially reduced touch screen actuation area. The method may additionally include increasing illumination of the predicted keys and or reducing illumination of the unlikely keys. Additionally, the color of the unlikely keys may be altered compared to the predicted keys.

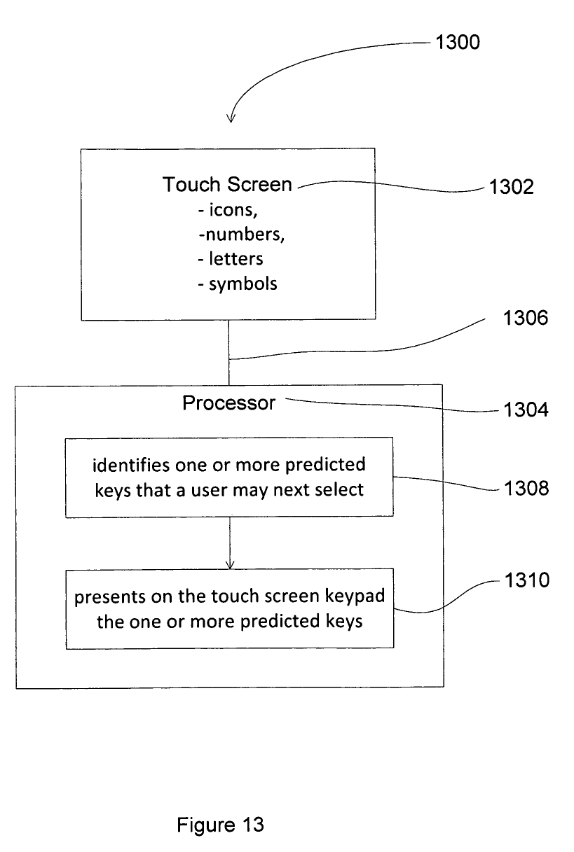

Referring to FIG. 13, a preferred embodiment of a system 1300 for enabling a user to quickly identify and select an keys on a touch screen keypad 1302 includes a touch screen that provides the user with the touch screen keypad for selection of at least one key selected from the group consisting of icons, numbers, letters and symbols, and a processor 1304 communicably coupled 1306 to the touch screen. The processor identifies 1308 one or more predicted keys that a user may next select and presents 1310 on the touch screen keypad the one or more predicted keys. The one or more predicted keys are enlarged to substantially fill the area of the touch screen previously occupied by a touch screen keypad initially provided to the user.

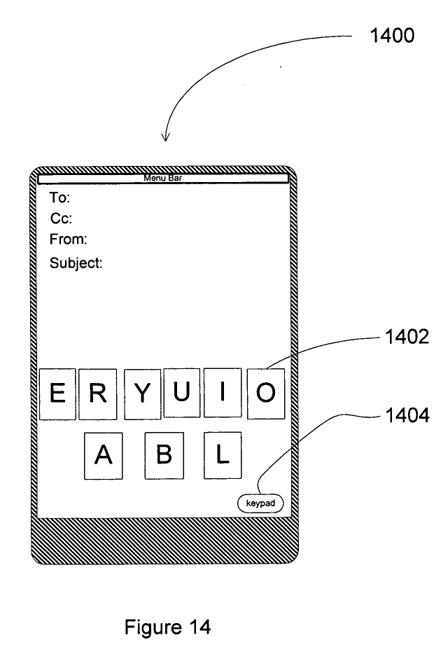

Referring to FIG. 14, in the preferred embodiment of the system 1400 the processor may modify the size of the one or more predicted keys 1402 to become at least twice the size of original keys on the keypad initially provided to the user and or provide a key for selection 1404 which allows retention of or the return to the keypad initially provided to the user. The layout of the at least one key upon the touch screen keypad is selected from the group consisting of QWERTY, Dvorak Simplified, alphabetical, numeric, and alphanumeric, or the layout may retain the same order as the full keyboard where the keys not predicted are removed as user choices from the touch screen keypad.

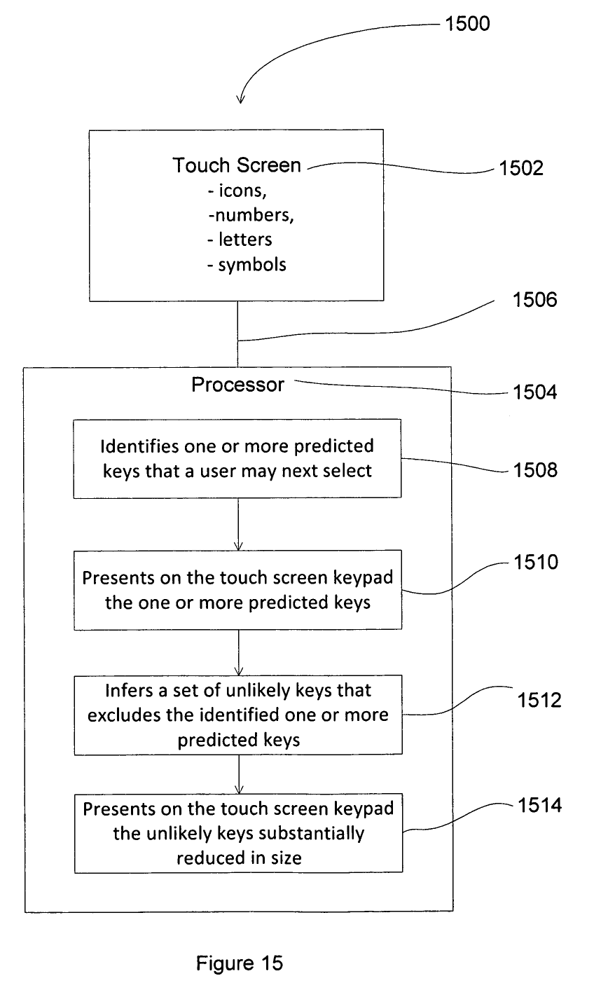

Referring to FIG. 15, a second embodiment of a system 1500 for enabling a user to quickly identify and select keys on a touch screen keypad includes a touch screen 1502 that provides the user with the touch screen keypad for selection of at least one keys selected from the group consisting of icons, numbers, letters and symbols. A processor 1504 is communicably coupled 1506 to the touch screen, wherein the processor identifies 1508 one or more predicted keys that a user may next select and presents 1510 on the touch screen keypad the one or more predicted keys. The processor infers 1512 a set of unlikely keys that excludes the identified one or more predicted keys and presents 1514 on the touch screen keypad the unlikely keys, which are provided substantially reduced in size.

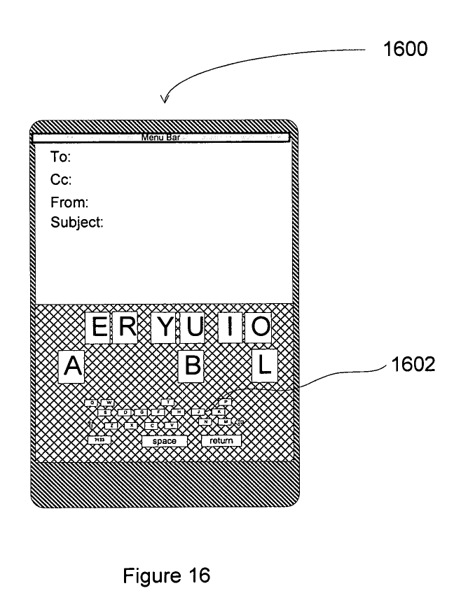

Referring to FIG. 16, the second embodiment of the system 1600 shows the unlikely keys 1602, which are provided substantially reduced in size (or intensity of illumination or both). Also the color of illumination may also change.

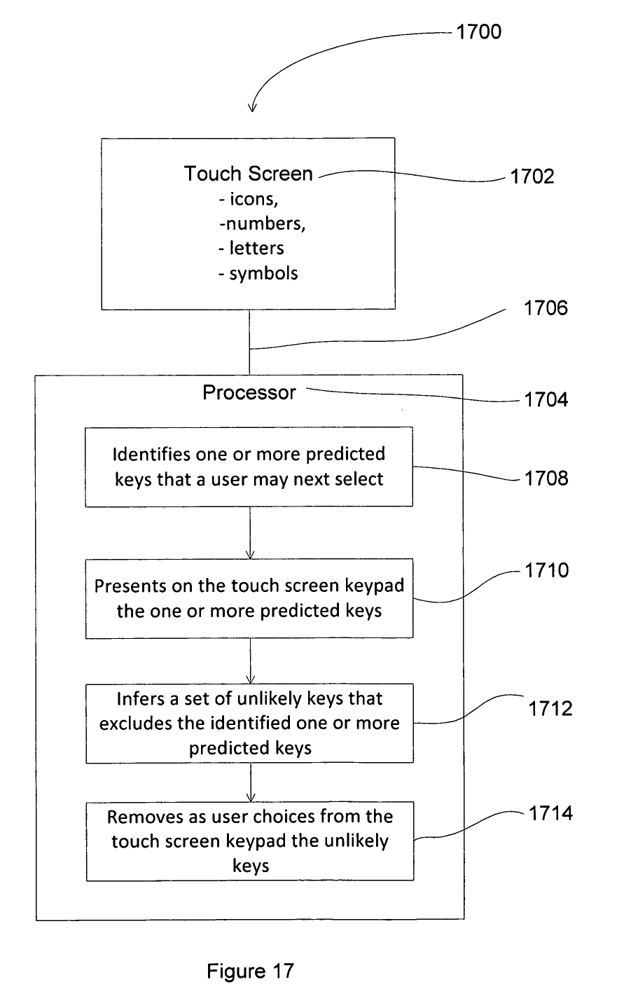

Referring to FIG. 17. a third embodiment of a system 1700 for enabling a user to quickly identify and select a key on the touch screen keypad includes a touch screen 1702 that provides the user with the touch screen keypad for selection of at least one key selected from the group consisting of icons, numbers, letters and symbols. A processor 1704 is communicably coupled 1706 to the touch screen. The processor identifies 1708 one or more predicted keys that a user may next select and presents 1710 on the touch screen keypad the one or more predicted keys. The processor infers 1712 a set of unlikely keys that excludes the identified one or more predicted keys and removes 1714 the unlikely keys as user choices from the touch screen keypad.

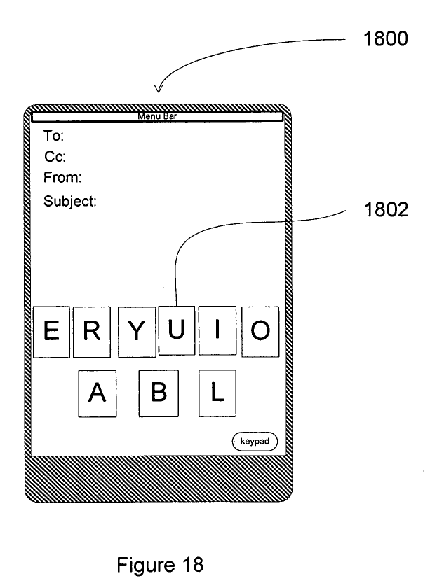

Referring to FIG. 18. the third embodiment of the system 1800 shows that the unlikely keys as having been removed and only the predicted keys 1802 remaining visible on the touch screen keypad.

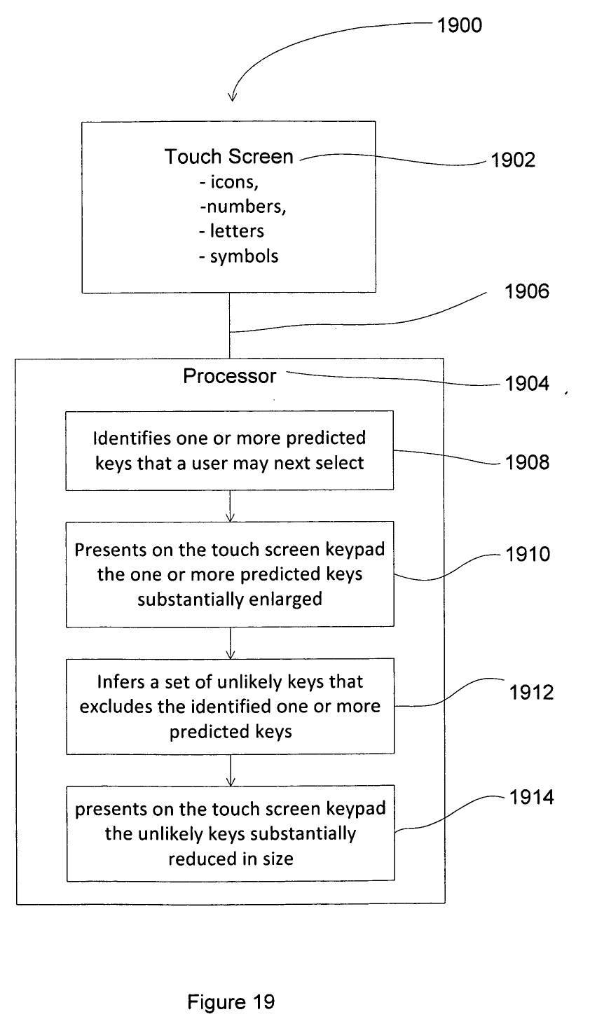

Referring to FIG. 19, a fourth embodiment of a system 1900 for enabling a user to quickly identify and select a key on a touch screen keypad includes a touch screen 1902 that provides the user with the touch screen keypad for selection of at least one key selected from the group consisting of icons, numbers, letters and symbols and a processor 1904 is communicably coupled 1906 to the touch screen. The processor identifies 1908 one or more predicted keys that a user may next select and presents 1910 on the touch screen keypad the one or more predicted keys. The processor infers 1912 a set of unlikely keys that excludes the identified one or more predicted keys and presents 1914 on the touch screen keypad the unlikely keys.

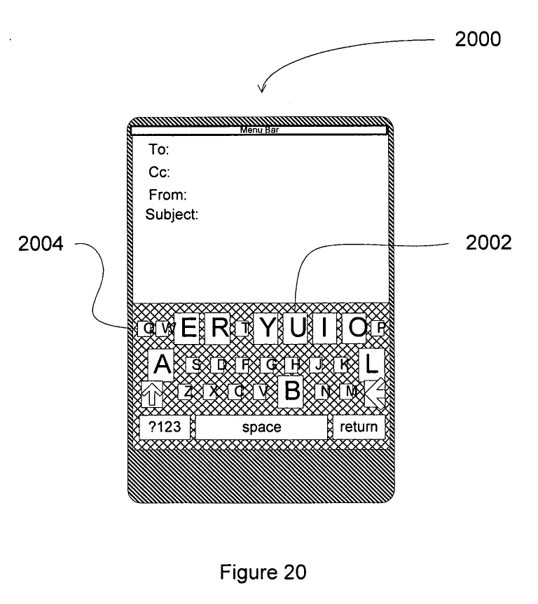

Referring to FIG. 20, the fourth embodiment of the system 2000 shows the presentation of the one or more predicted keys 2002 is substantially enlarged, and the unlikely keys 2004 are presented substantially reduced in size and/or illumination and/or color.

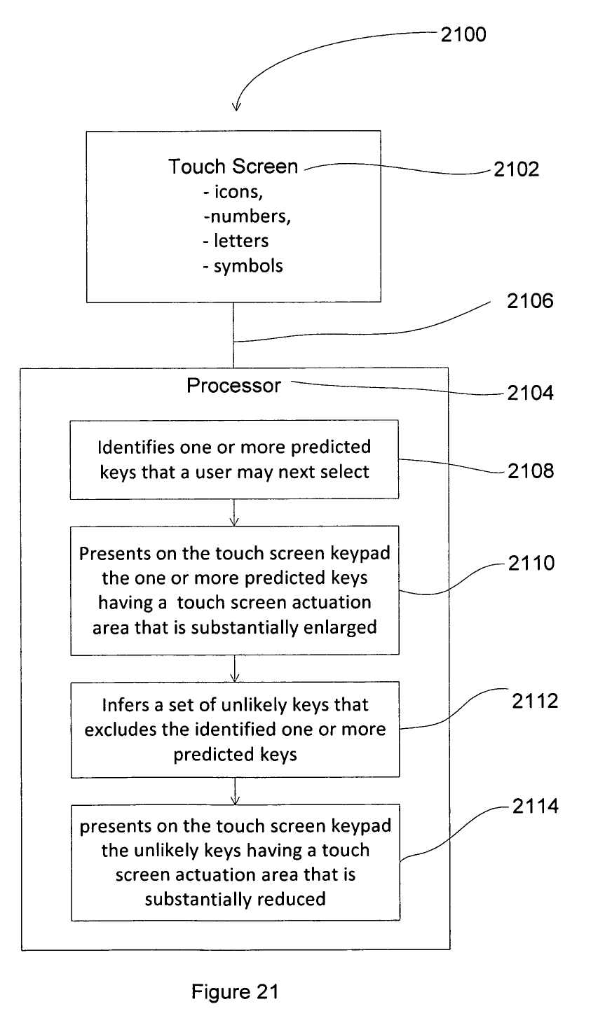

Referring to FIG. 21. a fifth embodiment of a system 2100 for enabling a user to quickly identify and select a key on the touch screen keypad includes a touch screen 2102 that provides the user with the touch screen keypad for selection of at least one key selected from the group consisting of icons, numbers, letters and symbols and a processor 2104 is communicably coupled 2106 to the touch screen. The processor identifies 2108 one or more predicted keys that a user may next select and presents 2120 on the touch screen keypad the one or more predicted keys. The processor infers 2112 a set of unlikely keys that excludes the identified one or more predicted keys and presents 2114 on the touch screen keypad the unlikely keys.

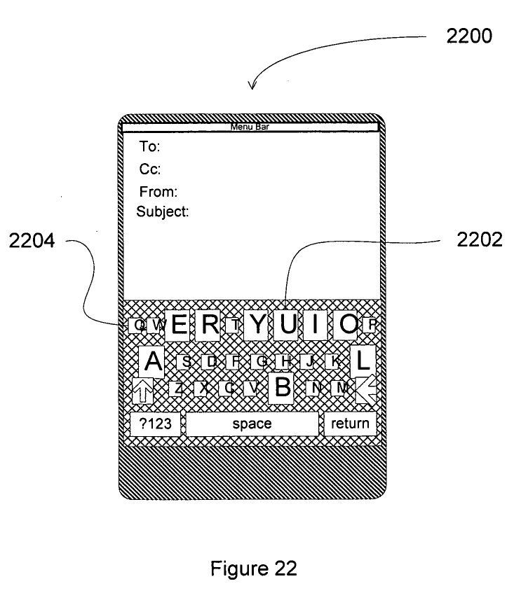

Referring to FIG. 22, the fifth embodiment of the system 2200 shows the one or more predicted keys 2202 have a touch screen actuation area that is substantially enlarged and the unlikely keys 2204 have a touch screen actuation area that is substantially reduced.

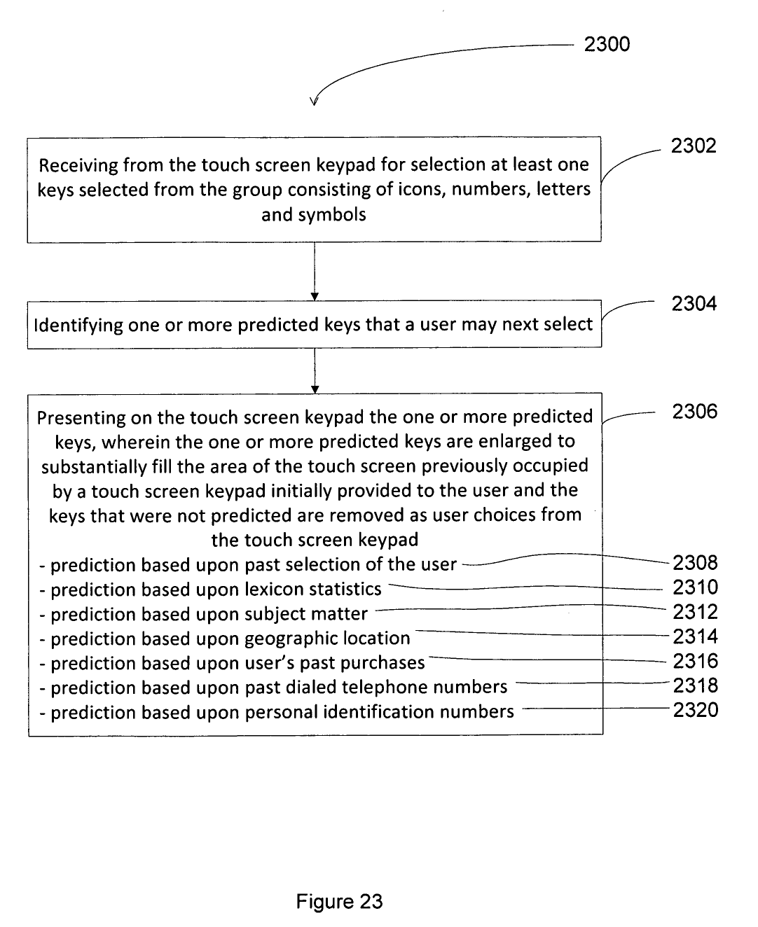

Referring to FIG. 23 a preferred embodiment of a computer usable medium 2300 that includes computer readable instructions for controlling a computer to enable a user to quickly identify and select a key on the touch screen keypad executes the steps of receiving 2302 from the touch screen keypad for selection of at least one key selected from the group consisting of icons, numbers, letters and symbols, identifying 2304 one or more predicted keys that a user may next select and presenting 2306 on the touch screen keypad the one or more predicted keys.

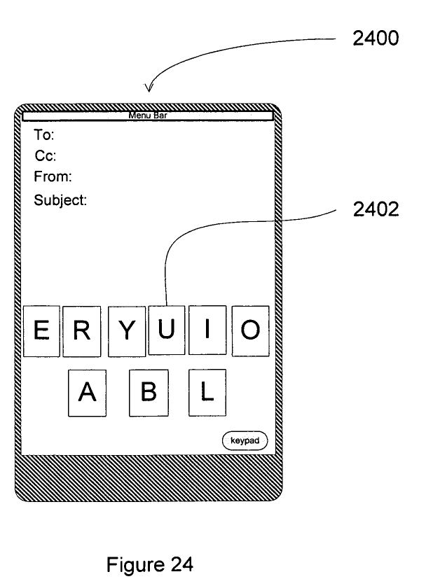

Referring to FIG. 24 the preferred embodiment of the computer usable medium 2400 shows the one or more predicted keys 2402 are enlarged to substantially fill the area of the touch screen previously occupied by a touch screen keypad initially provided to the user and the keys that were not predicted are removed as user choices from the touch screen keypad.

Referring to FIG. 23, the computer usable medium may also provide a key for selection which allows full alphanumeric selection, where the prediction is based upon past selections of the user 2308, lexicon statistics 2310, subject matter 2312, geographic location 2314, the user's past purchases 2316, past dialed telephone numbers 2318 and personal identification numbers 2320. The keys may include alphanumeric text. The touch screen may be a cellular telephone touch screen. The size of the one or more predicted keys may be at least twice the size of the original keys on the keypad initially provided to the user.

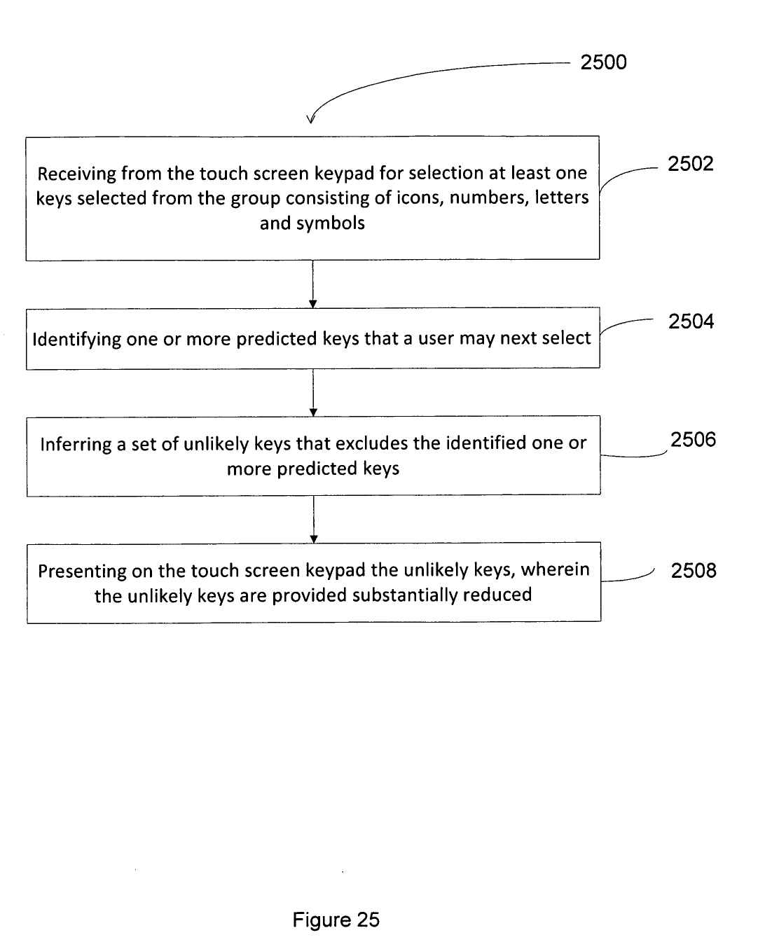

Referring to FIG. 25, a second embodiment of a computer usable medium that includes computer readable instructions for controlling a computer to enable a user to quickly identify and select a key on a touch screen keypad executes the steps of receiving 2502 from the touch screen keypad for selection at least one key selected from the group consisting of icons, numbers, letters and symbols and identifying 2504 one or more predicted keys that a user may next select. The executed steps include inferring 2506 a set of unlikely keys that excludes the identified one or more predicted keys, and presenting 2508 on the touch screen keypad both the predicted and the unlikely keys, wherein the unlikely keys are presented substantially reduced in size.

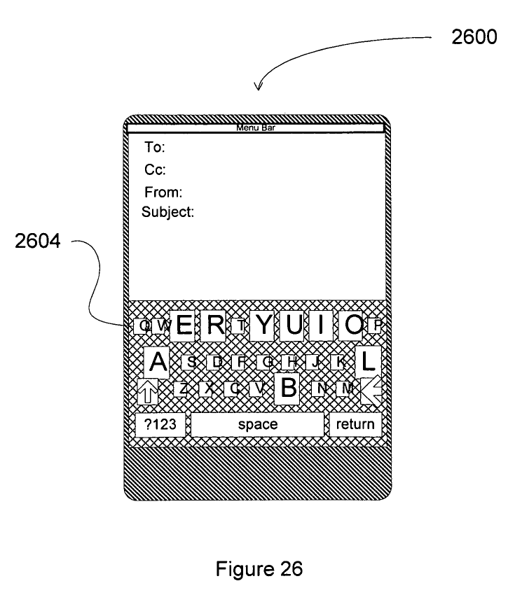

Referring to FIG. 26, the second embodiment of the computer usable medium 2600 shows the unlikely keys 2604 are presented substantially reduced in size.

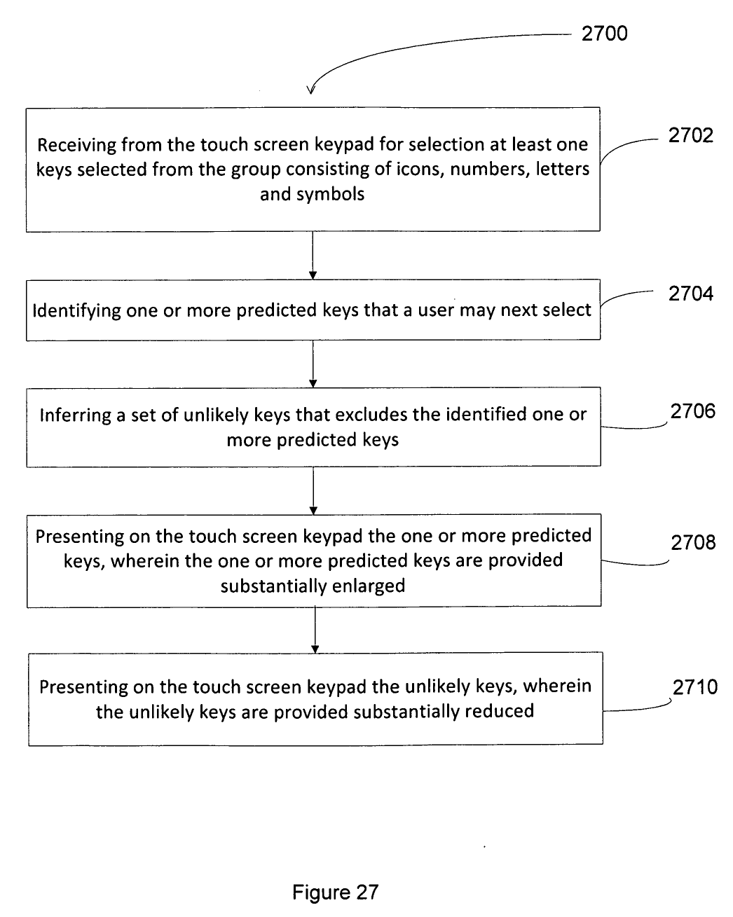

Referring to FIG. 27, a third embodiment of a computer usable medium 2700 that includes computer readable instructions for controlling a computer to enable a user to quickly identify and select an keys on a touch screen keypad executes the steps of receiving 2702 from the touch screen keypad for selection at least one key selected from the group consisting of icons, numbers, letters and symbols and identifying 2704 one or more predicted keys that a user may next select. The executed steps include inferring 2706 a set of unlikely keys that excludes the identified one or more predicted keys and presenting 2708 on the touch screen keypad the one or more predicted keys. The one or more predicted keys are presented substantially enlarged, and the unlikely keys are presented 2710 substantially reduced in size.

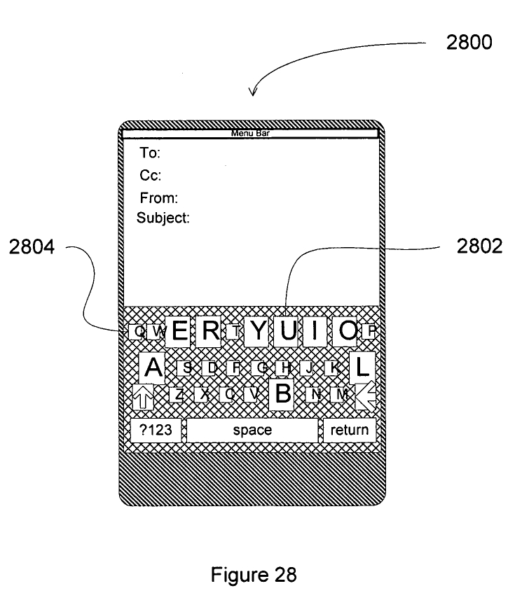

Referring to FIG. 28, the third embodiment of the computer usable medium 2800 shows the predicted keys 2802 being presented and the unlikely keys 2804 being presented substantially reduced in size.

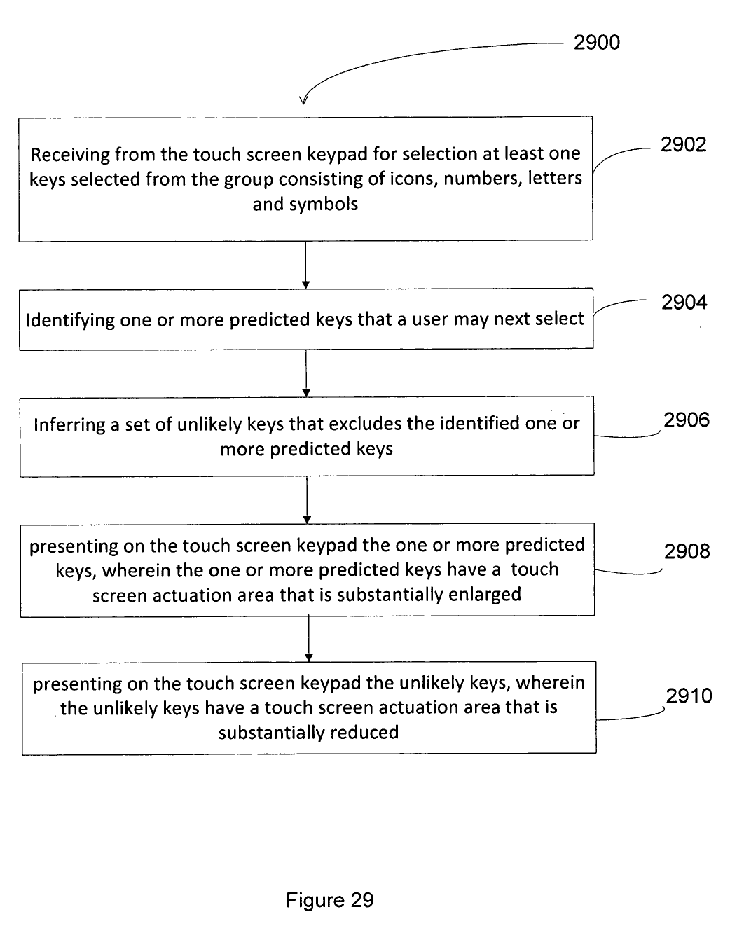

Referring to FIG. 29, a fourth embodiment of a computer usable medium 2900 that includes computer readable instructions for controlling a computer to enable a user to quickly identify and select a key on a touch screen keypad executes the steps of receiving 2902 from the touch screen keypad for selection at least one keys selected from the group consisting of icons, numbers, letters and symbols and identifying 2904 one or more predicted keys that a user may next select. The executed steps include inferring 2906 a set of unlikely keys that excludes the identified one or more predicted keys and presenting 2908 on the touch screen keypad the one or more predicted keys. The one or more predicted keys are then provided on a touch screen actuation area with an actuation area that is substantially enlarged and the unlikely keys are presented 2910 on a touch screen actuation area that is substantially reduced or essentially eliminated.

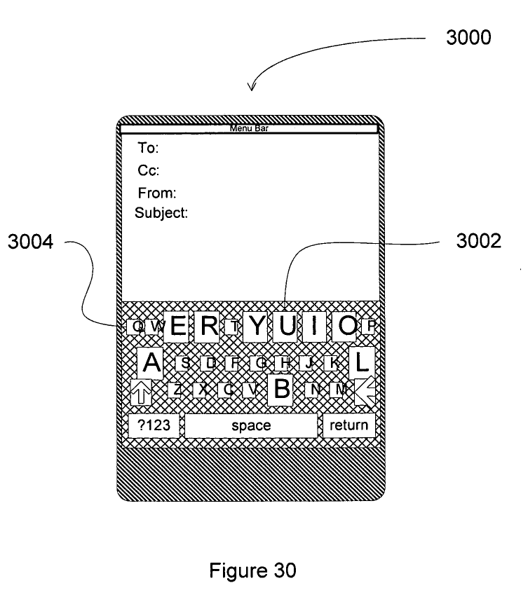

Referring to FIG. 30, the fourth embodiment of a computer usable medium 3000 shows the predicted keys 3002 have a touch screen actuation area that is substantially enlarged and the unlikely keys 3004 have a touch screen actuation area that is substantially reduced.

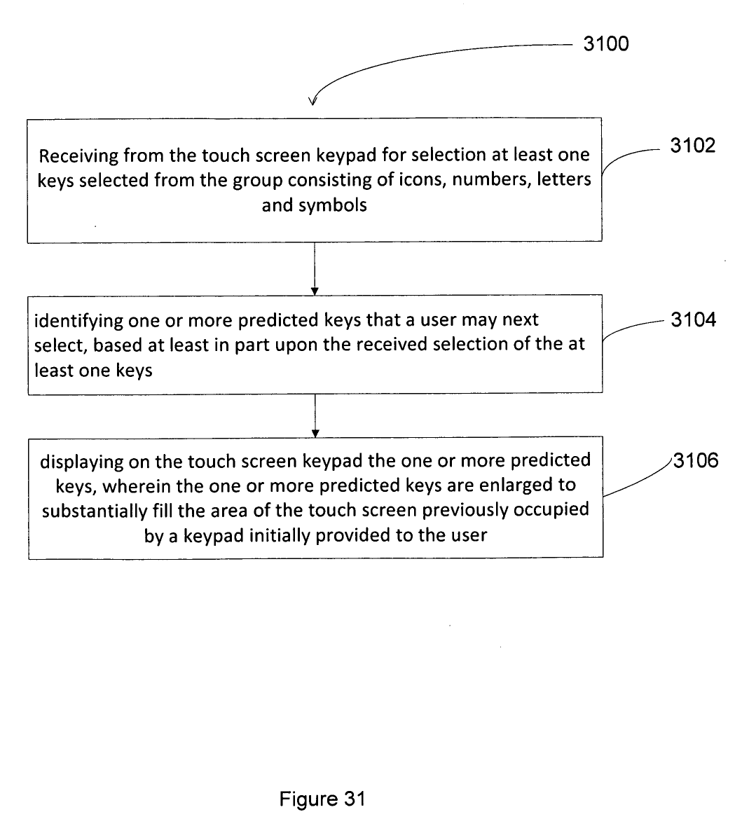

Referring to FIG. 31, a fifth embodiment of a computer usable medium 3100 that includes computer readable instructions for driving a touch screen display executes the steps of receiving 3102 at least one keys selection from a touch screen keypad, where the at least one keys is selected from the group consisting of icons, numbers, letters and symbols and identifying 3104 one or more predicted keys that a user may next select, based at least in part upon the received selection of the at least one keys. The executed steps include displaying 3106 on the touch screen keypad the one or more predicted keys that are enlarged to substantially fill the area of the touch screen previously occupied by a keypad initially provided to the user.

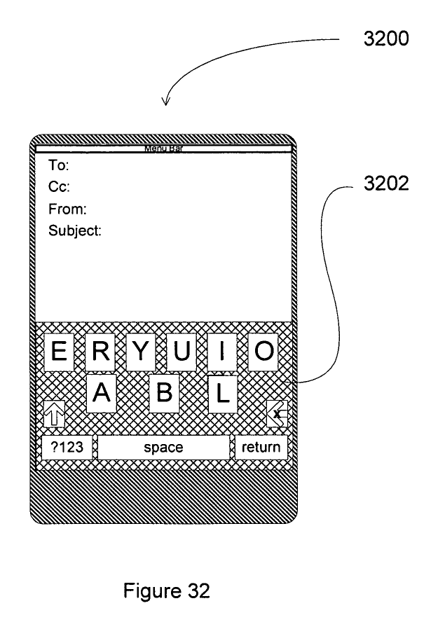

Referring to FIG. 32, the fifth embodiment of a computer usable medium 3200 shows the predicted keys 3202 are enlarged to substantially fill the area of the touch screen previously occupied by a keypad initially provided to the user.

These steps are preferably embodied in a computer readable medium or software but may also be embodied in firmware and are utilized via hardware. The steps performed in this figure are performed by software, hardware, firmware, and/or the combination of software, hardware, and/or firmware.

Although an exemplary embodiment of the system of the present invention has been illustrated in the accompanied drawings and described in the foregoing detailed description, it will be understood that the invention is not limited to any embodiment disclosed, but is capable of numerous rearrangements, modifications, and substitutions without departing from the spirit of the invention as set forth and defined by the following claims. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present embodiment, and/or to make the present invention more efficient.

What is claimed is:

1. A method for enabling a user to quickly identify and select a key on a touch screen keypad by easing keys selection, the method comprising:
providing the user with the touch screen keypad for selection of at least one key selected from the group consisting of icons, numbers, letters and symbols;
providing a predictive algorithm that identifies one or more predicted keys that a user may next select; and
presenting on the touch screen keypad the one or more predicted keys, wherein the one or more predicted keys are provided substantially enlarged.

2. A method as in claim 1 wherein the step of presenting comprises:
substantially filling the area with an enlarged one or more predicted keys such that the area previously occupied by a touch screen keypad initially provided to the user is filled.

3. The method of claim 1 further comprising, providing at least one key for selection which allows returning to the touch screen keypad initially provided to the user.

4. The method of claim 1 wherein the providing of the predicted keys size of the one or more predicted keys is accomplished by providing predicted keys in a size that is at least twice the size of an original key on the touch screen keypad initially provided to the user.

5. The method of claim 1 further comprising removing as user choices from the touch screen keypad the keys not predicted.

6. The method of claim 1 further comprising diminishing in size by approximately fifty percent or more the keys not predicted.

7. The method of claim 1 further comprising reducing in illumination the keys not predicted compared to the predicted keys.

8. The method of claim 1 further comprising altering the color of the keys not predicted compared to the predicted keys.

9. The method of claim 1 further comprising increasing in illumination the predicted keys.

10. The method of claim 1, further comprising providing said touch screen keypad on a cellular telephone.

11. The method of claim 1, further comprising biasing said prediction step based upon past selections of the user.

12. The method of claim 1, further comprising biasing said prediction step based upon lexicon statistics.

13. The method of claim 1, further comprising biasing said prediction step based upon subject matter.

14. The method of claim 1, further comprising biasing said prediction step based upon geographic location.

15. The method of claim 1, further comprising biasing said prediction step based upon the user's past purchases.

16. The method of claim 1, further comprising biasing said prediction step based upon past dialed telephone numbers.

17. The method of claim 1, further comprising biasing said prediction step based upon personal identification numbers.

18. A method for enabling a user to quickly identify and select keys on a touch screen keypad, the method comprising:
providing the user with the touch screen keypad for selection of at least one keys selected from the group consisting of icons, numbers, letters and symbols;
providing a predictive algorithm that identifies one or more predicted keys that a user may next select;
inferring a set of unlikely keys that excludes the identified one or more predicted keys; and
removing as user choices from the touch screen keypad the unlikely keys.

19. A method for enabling a user to quickly identify and select an keys on a touch screen keypad, the method comprising:
providing the user with the touch screen keypad for selection of at least one keys selected from the group consisting of icons, numbers, letters and symbols;
providing a predictive algorithm that identifies one or more predicted keys that a user may next select;
inferring a set of unlikely keys that excludes the identified one or more predicted keys;
presenting on the touch screen keypad the one or more predicted keys, wherein the one or more predicted keys are provided substantially enlarged; and
presenting on the touch screen keypad the unlikely keys, wherein the unlikely keys are provided substantially reduced.

20. The method of claim 19 further comprising, reducing illumination of the unlikely keys.

21. The method of claim 20 further comprising, increasing illumination of the predicted keys.

22. The method of claim 19 further comprising altering the color of the unlikely keys compared to the predicted keys.

23. The method of claim 19 grouping the unlikely keys into a separate area of the display from the predicted keys.

24. The method of claim 19 segregating the unlikely keys into a separate area of the display from the predicted keys.

25. A method for enabling a user to quickly identify and select a key on a touch screen keypad, the method comprising:
providing the user with the touch screen keypad for selection of at least one keys selected from the group consisting of icons, numbers, letters and symbols;
providing a predictive algorithm that identifies one or more predicted keys that a user may next select;
inferring a set of unlikely keys that excludes the identified one or more predicted keys;
presenting on the touch screen keypad the one or more predicted keys, wherein the one or more predicted keys have a substantially enlarged touch screen actuation area; and
presenting on the touch screen keypad the unlikely keys, wherein the unlikely keys have a substantially reduced touch screen actuation area.

26. The method of claim 25, further comprising, increasing illumination of the predicted keys.

27. The method of claim 25, further comprising, reducing illumination of the unlikely keys.

28. The method of claim 25 further comprising altering the color of the unlikely keys compared to the predicted keys.

29. A system for enabling a user to quickly identify and select an keys on a touch screen keypad, the system comprising:
a touch screen that provides the user with the touch screen keypad for selection of at least one keys selected from the group consisting of icons, numbers, letters and symbols; and
a processor communicably coupled to the touch screen, wherein the processor identifies one or more predicted keys that a user may next select and presents on the touch screen keypad the one or more predicted keys, wherein the one or more predicted keys are enlarged to substantially fill the area of the touch screen previously occupied by a touch screen keypad initially provided to the user.

30. The system of claim 29 wherein the size of the one or more predicted keys is at least twice the size of an original keys on the keypad initially provided to the user.

31. The system of claim 29 wherein the processor provides a key for selection which allows retention of or the return to the keypad initially provided to the user.

32. The system of claim 29, wherein layout of the at least one keys upon the touch screen keypad is selected from the group consisting of QWERTY, Dvorak Simplified, alphabetical, numeric, and alphanumeric.

33. The system of claim 29, wherein layout of the at least one keys upon the touch screen keypad is in the same order as the full keyboard.

34. The system of claim 29 where the keys not predicted are removed as user choices from the touch screen keypad.

35. A system for enabling a user to quickly identify and select an keys on a touch screen keypad, the system comprising:
a touch screen that provides the user with the touch screen keypad for selection of at least one keys selected from the group consisting of icons, numbers, letters and symbols; and
a processor communicably coupled to the touch screen, wherein the processor identifies one or more predicted keys that a user may next select and presents on the touch screen keypad the one or more predicted keys, wherein the processor infers a set of unlikely keys that excludes the identified one or more predicted keys and wherein the processor presents on the touch screen keypad the unlikely keys, wherein the unlikely keys are provided substantially reduced.

36. A system for enabling a user to quickly identify and select a key on the touch screen keypad, the system comprising:
a touch screen that provides the user with the touch screen keypad for selection of at least one key selected from the group consisting of icons, numbers, letters and symbols; and
a processor communicably coupled to the touch screen, wherein the processor identifies one or more predicted keys that a user may next select and presents on the touch screen keypad the one or more predicted keys, wherein the processor infers a set of unlikely keys that excludes the identified one or more predicted keys and wherein the processor removes as user choices from the touch screen keypad the unlikely keys.

37. A system for enabling a user to quickly identify and select a key on a touch screen keypad, the system comprising:
a touch screen that provides the user with the touch screen keypad for selection of at least one key selected from the group consisting of icons, numbers, letters and symbols; and
a processor communicably coupled to the touch screen, wherein the processor identifies one or more predicted keys that a user may next select and presents on the touch screen keypad the one or more predicted keys, wherein the processor infers a set of unlikely keys that excludes the identified one or more predicted keys and wherein the processor presents on the touch screen keypad the unlikely keys, wherein the one or more predicted keys are substantially enlarged, and wherein the unlikely keys are provided substantially reduced.

38. A system for enabling a user to quickly identify and select a key on the touch screen keypad, the system comprising:
a touch screen that provides the user with the touch screen keypad for selection of at least one key selected from the group consisting of icons, numbers, letters and symbols; and
a processor communicably coupled to the touch screen, wherein the processor identifies one or more predicted keys that a user may next select and presents on the touch screen keypad the one or more predicted keys, wherein the processor infers a set of unlikely keys that excludes the identified one or more predicted keys and wherein the processor presents on the touch screen keypad the unlikely keys, wherein the one or more predicted keys have a touch screen actuation area that is substantially enlarged and wherein the unlikely keys have a touch screen actuation area that is substantially reduced.

39. A computer usable medium comprising computer readable instructions for controlling a computer to enable a user to quickly identify and select a key on the touch screen keypad executing the steps of:
receiving from the touch screen keypad for selection at least one keys selected from the group consisting of icons, numbers, letters and symbols;
identifying one or more predicted keys that a user may next select; and
presenting on the touch screen keypad the one or more predicted keys, wherein the one or more predicted keys are enlarged to substantially fill the area of the touch screen previously occupied by a touch screen keypad initially provided to the user and the keys that were not predicted are removed as user choices from the touch screen keypad.

40. The computer usable medium of claim 39 further comprising, providing a key for selection which allows full alphanumeric selection.

41. The computer usable medium of claim 39, further comprising biasing said prediction step based upon past selections of the user.

42. The computer usable medium of claim 39, further comprising biasing said prediction step based upon lexicon statistics.

43. The computer usable medium of claim 39, further comprising biasing said prediction step based upon subject matter.

44. The computer usable medium of claim 39, further comprising biasing said prediction step based upon geographic location.

45. The computer usable medium of claim 39, further comprising biasing said prediction step based upon the user's past purchases.

46. The computer usable medium of claim 39, further comprising biasing said prediction step based upon past dialed telephone numbers.

47. The computer usable medium of claim 39, further comprising biasing said prediction step based upon personal identification numbers.

48. The computer usable medium of claim 39, further comprising increasing the size of the one or more predicted keys is at least twice the size of an original keys on the keypad initially provided to the user.

49. A computer usable medium comprising computer readable instructions for controlling a computer to enable a user to quickly identify and select a key on a touch screen keypad executing the steps of:
receiving from the touch screen keypad for selection at least one keys selected from the group consisting of icons, numbers, letters and symbols;
identifying one or more predicted keys that a user may next select;
inferring a set of unlikely keys that excludes the identified one or more predicted keys; and
presenting on the touch screen keypad the unlikely keys, wherein the unlikely keys are provided substantially reduced.

50. A computer usable medium comprising computer readable instructions for controlling a computer to enable a user to quickly identify and select an keys on a touch screen keypad executing the steps of:
receiving from the touch screen keypad for selection at least one keys selected from the group consisting of icons, numbers, letters and symbols;
identifying one or more predicted keys that a user may next select;
inferring a set of unlikely keys that excludes the identified one or more predicted keys;
presenting on the touch screen keypad the one or more predicted keys, wherein the one or more predicted keys are provided substantially enlarged; and
presenting on the touch screen keypad the unlikely keys, wherein the unlikely keys are provided substantially reduced.

51. A computer usable medium comprising computer readable instructions for controlling a computer to enable a user to quickly identify and select a key on a touch screen keypad executing the steps of:
receiving from the touch screen keypad for selection at least one keys selected from the group consisting of icons, numbers, letters and symbols;
identifying one or more predicted keys that a user may next select;
inferring a set of unlikely keys that excludes the identified one or more predicted keys;
presenting on the touch screen keypad the one or more predicted keys, wherein the one or more predicted keys have a touch screen actuation area that is substantially enlarged; and
presenting on the touch screen keypad the unlikely keys, wherein the unlikely keys have a touch screen actuation area that is substantially reduced.

52. A computer usable medium comprising computer readable instructions for driving a touch screen display executing the steps of:
receiving at least one keys selection from a touch screen keypad, wherein the at least one keys is selected from the group consisting of icons, numbers, letters and symbols;
identifying one or more predicted keys that a user may next select, based at least in part upon the received selection of the at least one keys; and
displaying on the touch screen keypad the one or more predicted keys, wherein the one or more predicted keys are enlarged to substantially fill the area of the touch screen previously occupied by a keypad initially provided to the user.
